(19) United States
(12) Patent Application Publication
(10) Pub. No.: US 2004/0021019 A1
(43) Pub. Date: Feb. 5, 2004

(54) Mincing machine

(76) Inventors: Thomas Gaartz, Holzdamm (DE); Richard Meyenschein, Schriesheim (DE); Eberhard Haack, Martha Brautsch Halle (DE)

Correspondence Address: FULBRIGHT & JAWORSKI, LLP, 1301 MCKINNEY, SUITE 5100, HOUSTON, TX, 77010-3095, US

(21) Appl. No.: 10/296,855

(22) PCT Filed: May 30, 2001
(86) PCT No.: PCT/EP01/06163

(30) Foreign Application Priority Data
May 30, 2000 (DE) 100-26-825.0

(51) Int. Cl. B07B 13/00

(52) U.S. Cl. 241/92

(57) ABSTRACT

The shredding machine operates according to the mincer principle. The machine has a filling hopper for receiving the material to be shredded, a feed screw, a working screw and a following cutter set, in which the feed screw is mounted below the filling hopper in a housing of the shredding machine. The working screw is detachably connected in non-rotary manner to the feed screw. Between the feed screw and working screw is provided a precutting device and a split pressure housing surrounding the working screw is pivotably held on the housing. On a discharge-side end section of the pressure housing is detachably held a block cutter set, which alternately has coaxially arranged rotary and stationary cutting elements. The rotary cutting elements being located on a knife shaft connected in detachable, non-rotary manner to the working screw. The stationary cutting elements are braced with locking screws between an adaptor plate to be fixed at the discharge-side end section of the pressure housing and a support element, in which an end section of the knife shaft is mounted in rotary manner in the support element.

### TECHNICAL FIELD

The invention relates to a shredding machine more particularly for foods, e.g. deep-frozen meat and which operates according to the mincer principle, having a filling hopper for receiving the product to be shredded, a feed screw, a working screw and a following set of cutters.

### BACKGROUND OF THE INVENTION

The basic structure of known shredding machine is such that the feed process and the pressure buildup during shredding are determined by the feed and working screws, the pressure or profile tube (pressure housing) of the shredding machine and the raw material. The actual shredding process takes place through cutter systems located within the pressure housing.

In mincers the necessary pressure is maintained upstream of the cutting elements for as long as is allowed by the strength characteristics of the raw material to be shredded, particularly meat, which is in turn dependent on the adhesion or sticking of the raw materials to be shredded in the pressure housing. As a result of this adhesion between the pressure housing, the feed and working screws, and the raw material a mechanical connection takes place permitting the mincing material feed process. The feed thrust is built up by the raw material compression between individual screw channels of the feed and working screws and in the sum of all the compressions in the grooves of the pressure housing, producing a shearing force form on the raw material in the screw channels. This force is available for producing pressure on the raw material in the cutter set.

This means that in virtually all mincers, there is a so-called friction feed, relative to the mincing material conveyed, and consequently during shredding, reference can be made to the principle of fixing and cutting off the mincing material.

The function-determining elements are located within the shredding machine and in the pressure housing, the latter being constructed as a closed unit, which is fixed to a basic housing of the shredding machine. On the discharge side of the pressure housing, behind the final screw channel, there are cutting elements in the form of a cutter set in a closed cutter part housing in which the shredding process takes place. By means of a bracing unit preferably constructed as a clamping nut, the bracing of the cutter set takes place within the cutter part housing and with the working screw.

If it is necessary to dismantle or replace cutter set parts or also the working or feed screw, such as e.g. in the case of a fault, or changing to other working conditions or for cleaning purposes, considerable effort is required for removing the parts out of the housing, followed by the reassembly of the individual components and the mutual, functionally correct matching and setting.

A variability, through the exchange of individual subassemblies, is scarcely possible or only possible with great effort and expenditure in the known solutions.

The problem of the invention is to improve such a shredding machine in such a way that individual subassemblies can be changed or replaced without extensive effort. Easy accessibility to the feed elements is possible and a variability of the individual subassemblies for the feeding and shredding process, as a function of the necessary operating conditions, is possible. Particular importance is attached to accessibility from the outside, so that it is possible to directly introduce, at individual cutter set parts technical media such as heat, cold, additives, etc.

### BRIEF SUMMARY OF THE INVENTION

According to the invention this problem is solved by claim 1, wherein the shredding machine operates according to the mincer principle. The machine has a filling hopper for receiving the material to be shredded, a feed screw, a working screw and a following cutter set, in which the feed screw is mounted below the filling hopper in a housing of the shredding machine. The working screw is detachably connected in non-rotary manner to the feed screw. Between the feed screw and working screw is provided a precutting device and a split pressure housing surrounding the working screw is pivotably held on the housing. On a discharge-side end section of the pressure housing is detachably held a block cutter set, which alternately has coaxially arranged rotary and stationary cutting elements. The rotary cutting elements being located on a knife shaft connected in detachable, non-rotary manner to the working screw. The stationary cutting elements are braced with locking screws between an adaptor plate to be fixed at the discharge-side end section of the pressure housing and a support element, in which an end section of the knife shaft is mounted in rotary manner in the support element. Preferred developments of the invention are described in the subclaims.

### BRIEF DESCRIPTION OF THE DRAWINGS

The invention is explained relative to an embodiment and the attached drawings, wherein show:

FIG. 1 is a perspective overall view of a shredding machine according to the invention.

FIG. 2 are two perspective views of a mincer with a pivoted on pressure housing.

FIG. 3 is a pivoted on pressure housing with inserted precutter.

FIG. 4 is two representations of a mincer with closed pressure housing.

FIG. 5 is a sectional view of the block cutter set.

FIG. 5 is a detail of the knife cutter set according to FIG. 5 on a larger scale.

FIG. 6 is a plan view of a knife spacer.

FIG. 7 is an overall view, partly in section, of the body and working screws.

FIG. 8 is a sectional view of a working screw.

FIG. 9 is a lateral view of a body screw.

### DETAILED DESCRIPTION OF THE INVENTION

A feeding and shredding system for shredding machines has been created operating according to the mincer principle. The feeding and shredding system ensures high variability for a mincer, which can be equipped with several cutter sets for preshredding and maintaining the pressure, as well as for final shredding and for the introduction of technical media or additives. The final cutter set can be constructed as a coupleable, pretensioned and housing-free block cutter set. The block cutter set is a closed subassembly and can be fixed by means of corresponding adaptor devices to the mincer pressure housing. The pressure housing can be longitudinally divided and comprises housing halves with smooth inner walls, which are equipped with shell-like or tray-like raw material support systems.

The drive for all the elements providing for the feeding and shredding process takes place by means of a driving shaft journal, which can be connected by means of a double flange connection with security against fracture to the feed screw, which is constructed as a supplying body screw and is positively and non-positively connected to a following working screw. In the transition area, from the body screw to the following working screw, is provided a precutting system, which ensures preschredding, mounting and improved pressure maintenance for the raw material.

The working screw can be constructed with a hollow shaft and can be coupled to the driving shaft by means of correspondingly designed tongue and groove connections. The working screw is constructed as a double-start screw, whose discharge-side screw channels have a higher lead. On the flanks of the last two screw channels, pressure impulse pieces can be arranged in pairs, which bring about a quadripartition of the volume flow of the mincing material to all partial areas of a following perforated disk with corresponding raw material pretension, so that in this area the working screw is constructed as a four-flow divider screw.

The precutting system is provided in the transition area between the body screw and the working screw. It comprises cutting blades interchangeably arranged on the final screw channels of the body screw and a precutter located between the body screw and the working screw.

The block cutter set is driven by means of a knife journal, which on the drive side, and is constructed in such a way that there is a positive and non-positive connection with the smooth driving shaft of the feeding and shredding system.

The variability of the inventive machine and its operating characteristics leads to the advantage that the drive, with the driving shaft remaining in the installed manner, is equipped with security against fracture. The body screw, for the raw material supply, is constructed as a force transfer part for the cutting tools for coupling with the cutter set with integrated knife journal. Several, namely at least two cutting systems, can be used in the machine, which act as a precutting system with pressure stabilization and a final cutting system.

The pressure housing comprises two fold-up pressure housing halves, in which can be inserted corresponding feed shells or trays having grooves or so-called support baskets. The mincing material feed process is significantly aided and through the choice of the feed shells or support baskets, it is possible to directly influence the mincing material feed. This arrangement ensures a good force buildup during the feed process. These shells can be replaced if the raw material characteristics are modified.

Knowing that only the screw channels directly facing the cutter set build up pressure, the end section of the working screw has been constructed as a four-flow partitioning screw with a four-volume flow partition, in order to improve the raw material feed process through the cutter set. This means that the raw material, which is broken up through the geometrical reduction of the contours of the final screw channels and due to the pressure at the bore edges, enters the bores of the perforated disks, is cut off and is fed out of the bores of the perforated disks. The four-flow—volume flow divider simultaneously builds up the necessary feed pressure on the entire perforated disk surface and the full-area operation of the cutter set is ensured.

The block cutter set is positioned in such a way that at no point do the knives enter the feed flow of the four-flow divider screw and consequently, directly cooperate with the geometrical pressure buildup of the screw. The position of the knife bars, with respect to the final screw channels, fundamentally takes place in such a way that the pressure production in the raw material reached its maximum and then engagement takes place between the knives and perforated disk, so that a correct quality cutting is ensured.

The block cutter set is constructed as a housing-free cutter set. Spacers for the knife bodies ensure both the cutting action and also the sealing action between the individual components of the block cutter set. The individual cutter set parts are located on a knife journal and are braced by means of locking screws with an adapter plate by means of which the block cutter set is connected to the pressure housing. The support element of the block cutter set located at the discharge side is designed in such a way that it simultaneously functions as a support device and a discharge protection. A sleeve is centrally provided between the support element and the knife journal.

The precutting system provided between the body screw and the working screw is consequently associated with both functional subassemblies. The knife function is exerted by the cutting blades, which are associated with the screw and/or a separate knife body and are preferably positioned at the highest point of the final screw channel of the body screw in a double-start construction. The countercutter function is ensured by a precutter positioned between the body screw and the working screw, which is inserted in the hopper housing and is held in a twist-proof manner in its position by the hinged pressure housing. Spring elements in this area secure the precutter in the assembly state in its cutting position, specifically spaced from the cutting blades to attain the function of the precutting system.

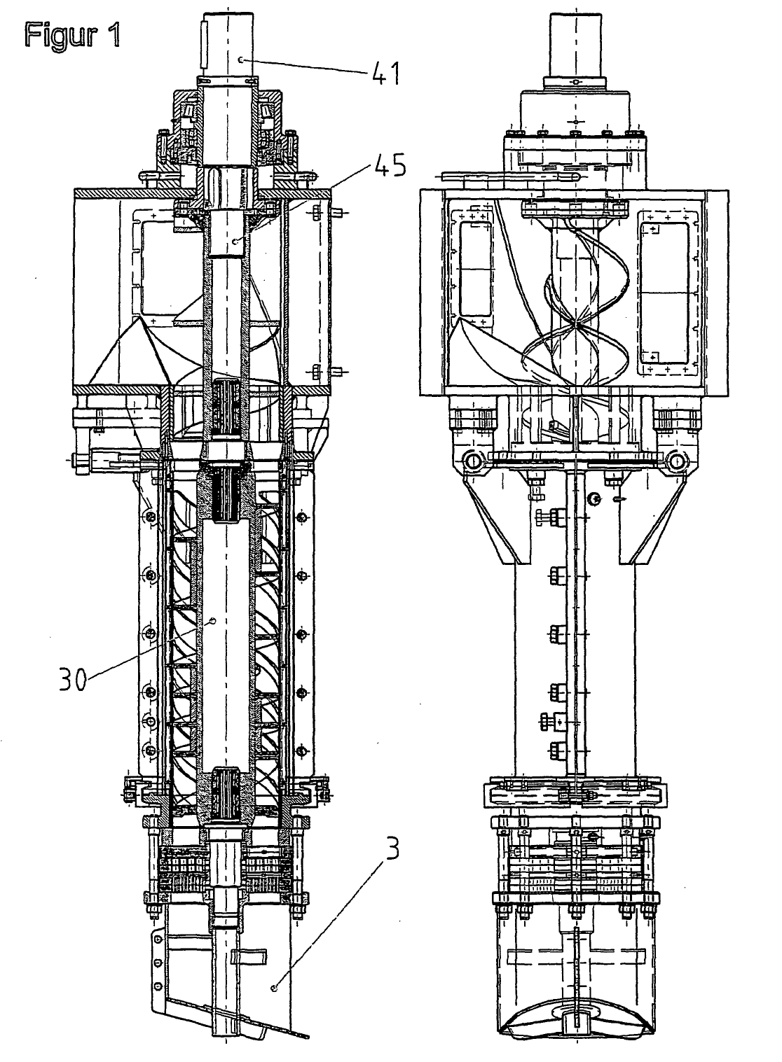

An embodiment of the shredding machine according to the invention including the feeding and shredding system is shown in overall view form in FIG. 1.

The basic housing 1 of a mincer with pressure housing 2 is connected by means of a pivoting device 4 to the housing 1. On the opposite side of the delivery or discharge side of the pressure housing 2 is located a block cutter set 3.

The pressure housing 2 is split and comprises two pressure housing halves 6, which are held on the housing 1 by means of the pivoting mechanism 5 and can be opened or closed with an adjusting mechanism 12.

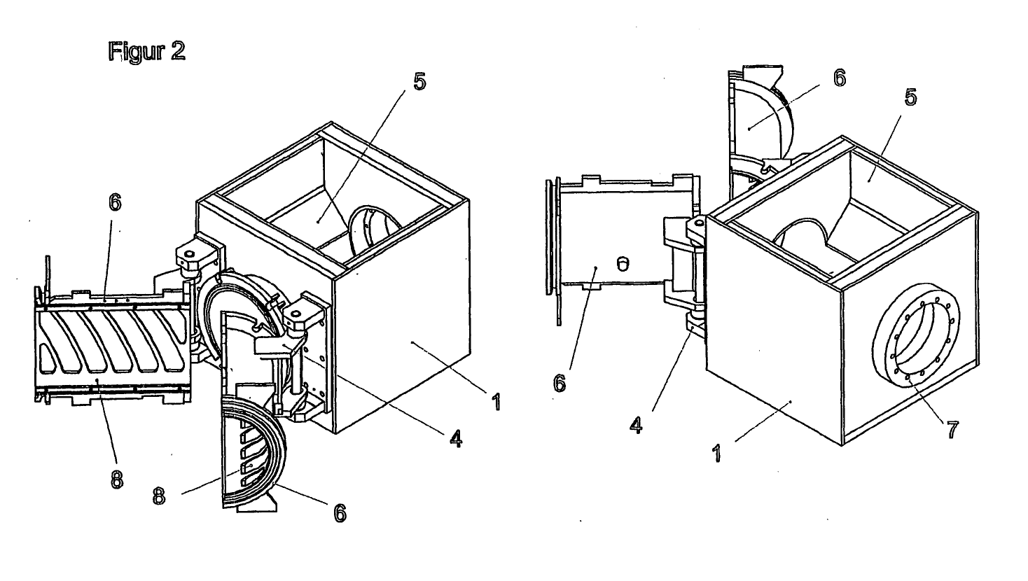

FIG. 2 is a perspective view with an opened pressure housing 2 and illustrates the constructions of the split pressure housing 2. The pressure housing halves 6 are largely constructed as half-shells, in which are interchangeably arranged support and twist units 8. The support and twist units 8 are half-shells constructed with flutes on their inner walls, which lead to grooves in the closed pressure housing 2, necessary for supporting the raw material to be processed within the pressure housing 2.

As an alternative to the construction as shell-like components, the support and twist units 8 can be constructed as support baskets, which are also split and interchangeably fixed in the pressure housing halves 6.

A filling hopper is located in the mincer housing 1 and is constructed on its driving side with a bearing 7.

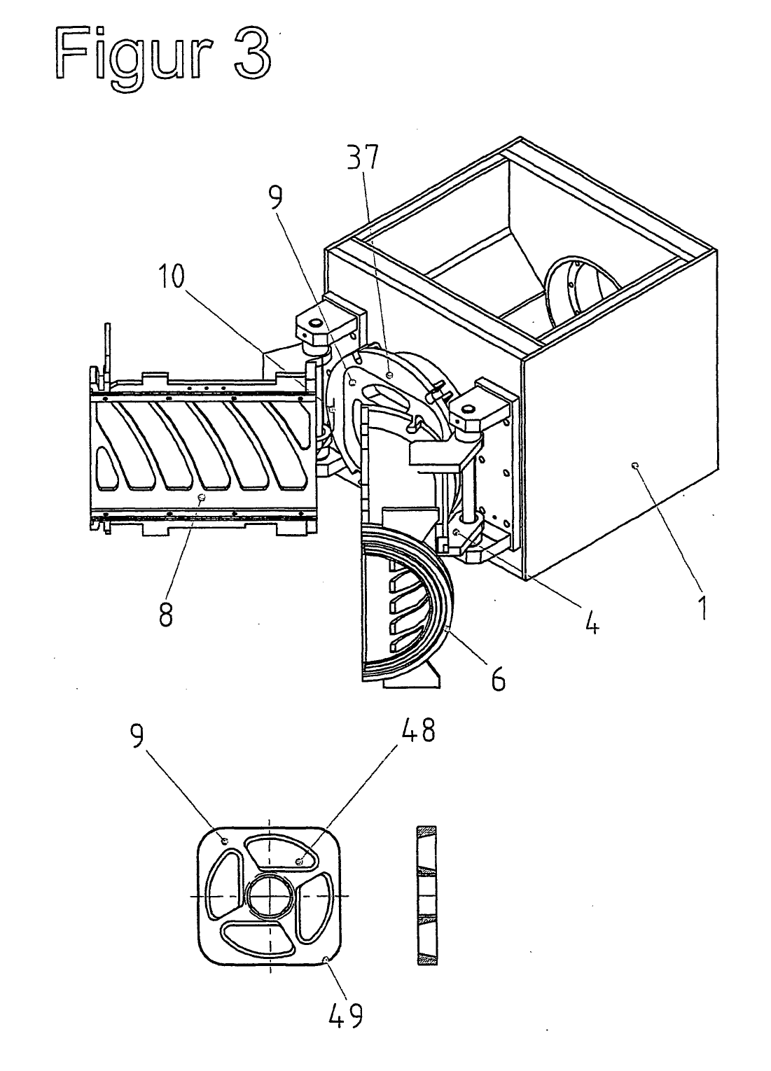

The arrangement and construction of the precutter 9 belonging to the precutting system can be gathered from FIG. 3. FIG. 3 illustrates on the upper figure the placing of the precutter 9 in the discharge-side flange 37 of the casing 1 and on the lower figure the shape and construction of the precutter 9. The precutter 9 is preferably constructed with a square outer contour 49, which ensures a twist-proof bearing. The passage openings 48 of precutter 9 can also be gathered from FIG. 3 and it is also shown that the precutter 9 is constructed with a bearing bush 47, in which is mounted the body screw 28.

In this area there is also a tension spring 10, which in the opened state of the pressure housing 2, presses against the precutter 9 and consequently prevents the latter from dropping out of its bearing when the pressure housing 2 is open.

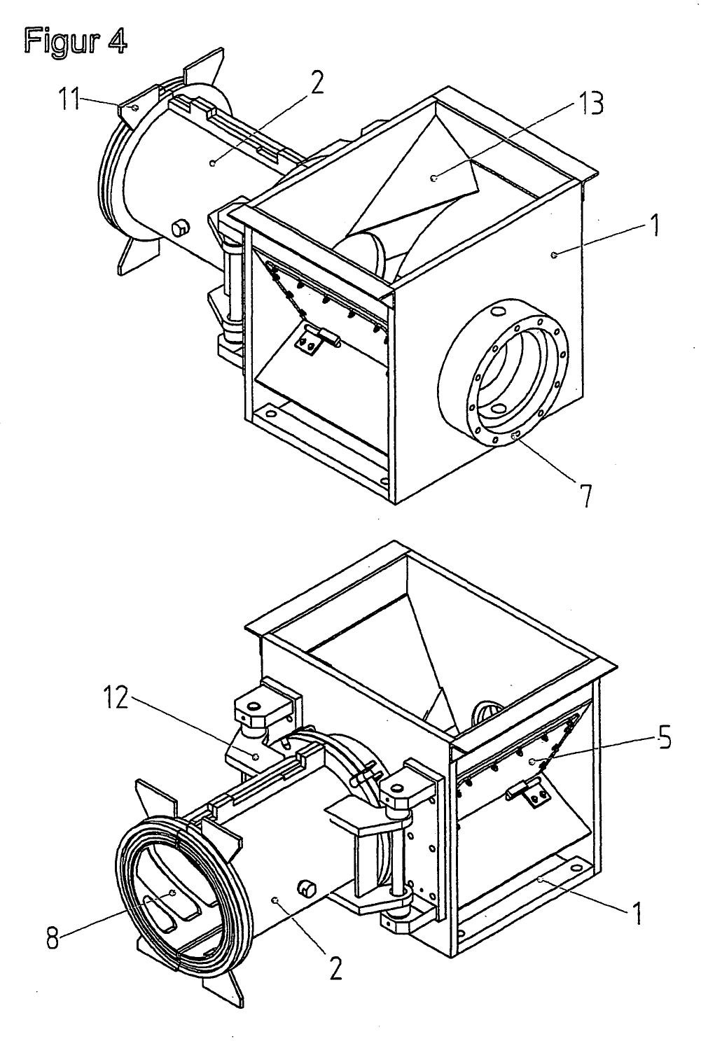

FIG. 4 shows in a perspective view the mincer filling hopper 5 located directly in the housing 1, which in the widest sense is trough-shaped, so that the bottom of the filling hopper 5 is located below the feeding body screw 28 mounted in the housing 1.

Above the body screw 28 inserted in this area, and above the filling hopper 5 is provided an entry aid 13, which has a wedge-shaped construction and an inclination directed towards the discharge-side opening of the hopper 5 in the raw material feed direction.

The entry aid 13 is a specially shaped moulding, which is arranged in a fixed or vertically adjustable manner on the inner wall of the filling hopper 5. The entry aid 13 serves to receive the mincing material and supply the same to the screw channels of the body screw 28, so as to ensure a continuous raw material flow. This is particularly advantageous when using deep-frozen and/or large raw material pieces, which tend to form bridges in the filling hopper 5, causing the supply to be interrupted and significantly reducing the effectiveness and efficiency of the mincer.

The entry aid 13 forms, as a result of the wedge-shaped construction of the entry bevel, a cutting or breaking edge bringing about a breaking up or a certain preshredding of the mincing material as it is delivered to the hopper 5.

The adjusting mechanism 12 for opening and closing the pressure housing 2 can be operated manually or with a drive mechanism.

The block cutter set 3, following the pressure housing 2, is constructed as a closed subassembly, which can be assembled in a desired form and then can be braced or attached in this form to the pressure housing 2 by means of the clamping or quick-acting locking closure 11. The locking closure 11 engages in the circumferential groove 17 of an adapter plate 16.

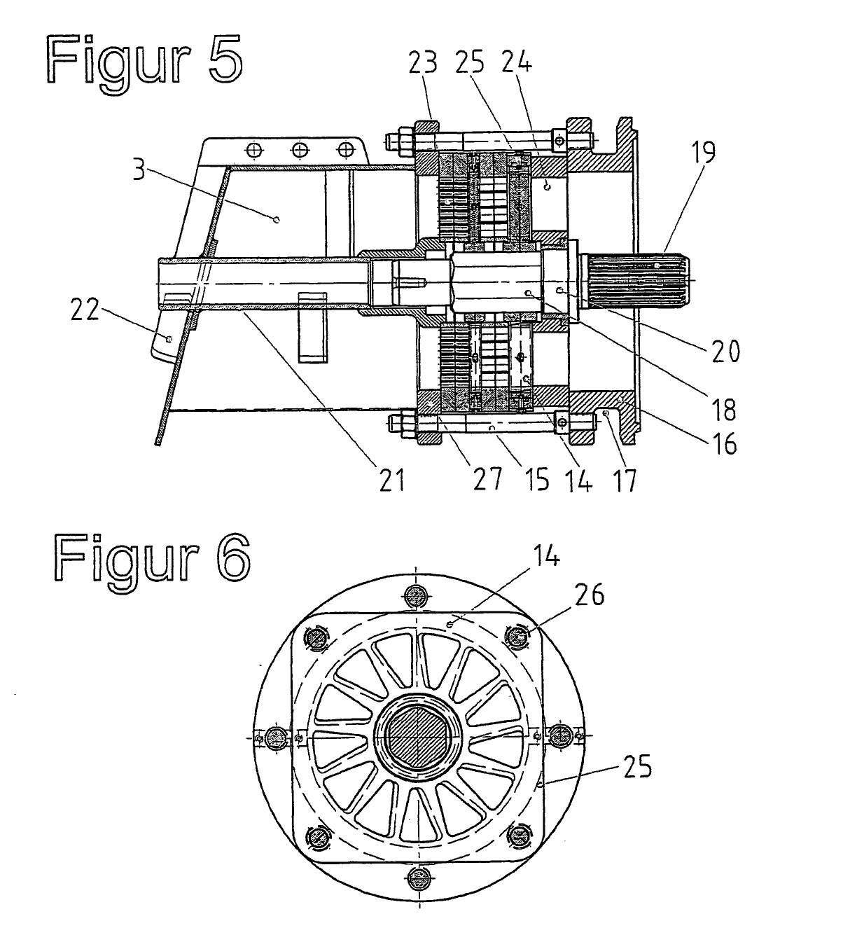

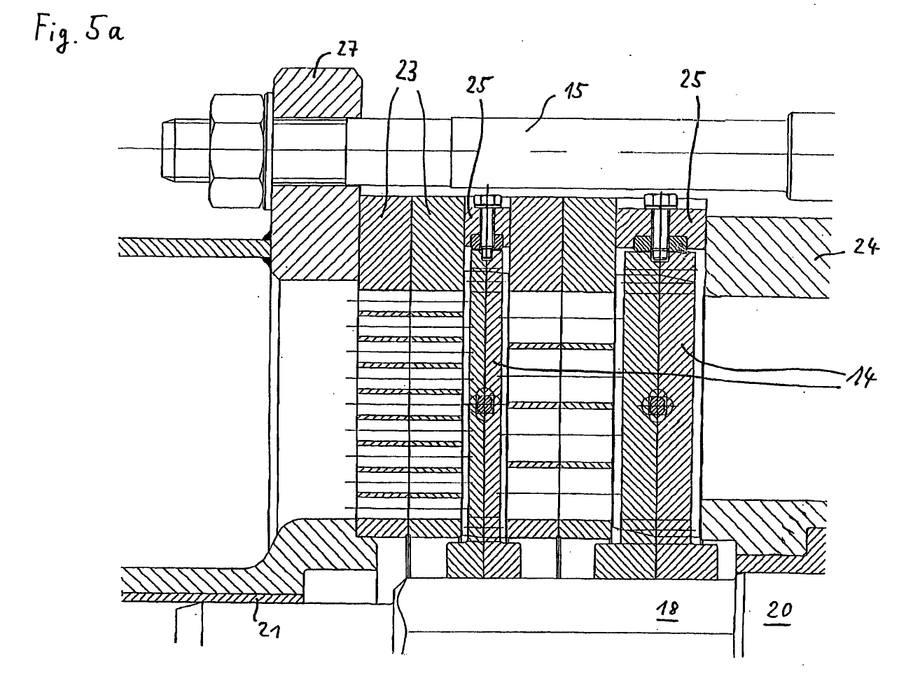

A block cutter set 3 is shown as a multipart cutter set in the assembled state in FIG. 5 and on a larger detail scale in FIG. 5a.

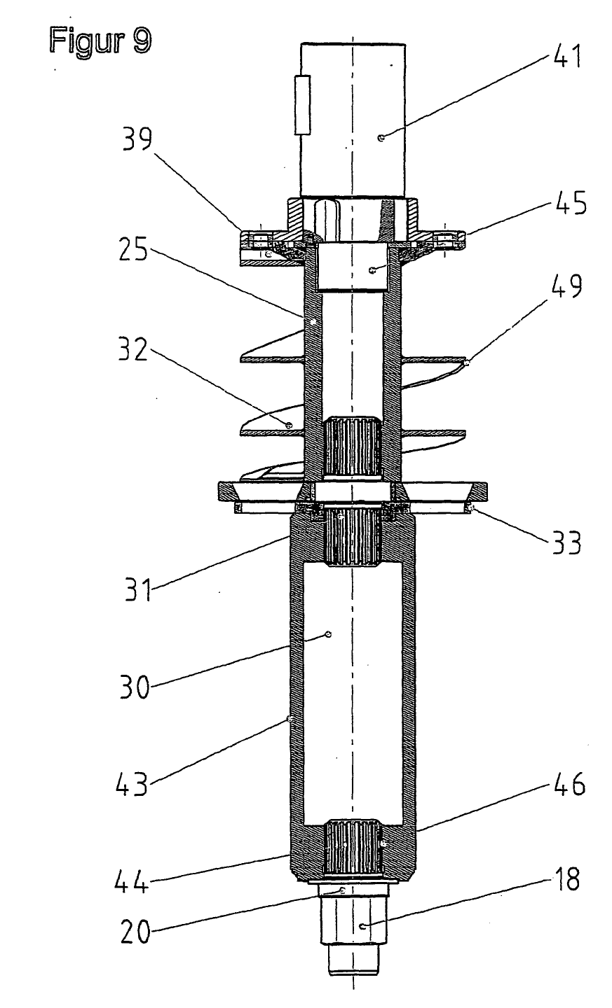

The individual cutter set parts such as the precutter 24, spacer knife 14 and perforated disks 23, are mounted on a knife journal 18, which has a connecting piece 20 with a hexagonal recess 19, with which the force transfer takes place to the inserted spacer knife 14. An axially aligned bracing of the cutter set parts takes place by means of a support element 22 having a sleeve 21 or a suitable bearing. The bracing of the cutter set parts takes place by means of locking screw 15, which are guided through bores 26 of the individual cutter set parts and connect to the adaptor plate 16. The cutter set parts are preferably square, as shown in FIG. 9.

A knife spacer 25 is associated with a spacer knife 14 in each case. As shown in FIG. 5a, a sliding insert 25a, which can be made from a suitable plastic, e.g. POM, is in each case positioned between a rotary spacer knife 14 and a stationary, tension force-absorbing spacer 25.

The connection of the block cutter set 3 to the driving shaft 43 takes place by means of the hexagonal recess 19 of the knife journal 18 and a tongue and groove connection 46.

Through the variability of the cutter set parts to be used, the block cutter set 3 takes account of the particular operating conditions. The perforated disks 23 can be combined with one another and the progressions of the bores of the perforated disks 23 are in a ratio of 1:4 to 1:8. The knife bar thickness of the inserted spacer knife 14 corresponds to approximately 80% of the bore diameter of the smallest perforated disk 23 used and the free faces of the perforated disks 23, i.e. the sum of the passage openings, always exceeds 60%. The number of knife bars of knives used increases towards the final perforated disk by 50% in each case and the knife bar thicknesses are reduced by 25 to 40%, so that the number of cutting planes is determined by the bore size factor of the perforated disks 23 and decreases relative to the final perforated disk to a size of 1:2.

The free interchangeability of the individual perforated disks or knife spacers has the advantage, as compared with conventional cutter sets located in a fixed housing, in that the cutting elements can be used differently until an extensive material wear occurs and if need be they can be turned within the cutter set, so that the overall life of individual cutting elements and the overall block cutter set is significantly increased. Through the formation of a perforated disk set, from both a relatively strongly worn and conventionally no longer usable perforated disk and a new or a less worn perforated disk, a much longer utilization of the disks, up to 10% of the residual thickness or 90% of the wall thickness present in the new state, is possible. Utilizations of 25 to 35% of the wall thickness present in the new state are possible because subsequent mechanical instabilities occur.

It is also possible to provide the individual cutter set parts with connections 27 by means of which additives or other media can be directly introduced into the shredding process, so as to influence the consistency and quality of the end product. Alternatively or additionally, measuring devices can be connected in order to give information on the prevailing operating conditions such as temperature, pressure, feed rate and raw material consistency.

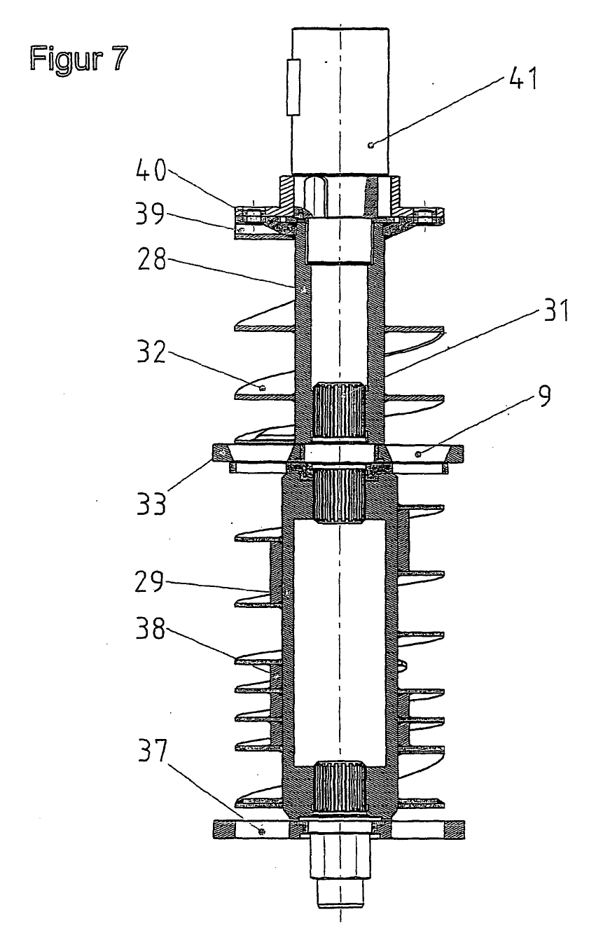

The feed and working screws are shown in an overall view in FIG. 7, which reveals that the feed screw (body screw 28) and following working screw 29, are two separate components interconnected by means of a tongue and groove connection 31. The body screw 28 is connected by means of a double flange connection 39 to the driving shaft journal 41, the double flange connection 39 is equipped with an overload protection means in the form of shear pins 40. Through the variability of the plug connection (e.g. multi-spline or polygonal connection) between the feed and working screws, it is possible to adjust the angle or rotary position of the two screws relative to one another, so that their position can be optimized as a function of the processed raw material and its state.

As the connection point between the body screw 28 and working screw 29 is located the precutting system with cutting blades 33, which are provided at the screw channels 32 of the body screw 28 and a precutter 34, which is mounted in the discharge-side flange 37 of the mincer housing 1.

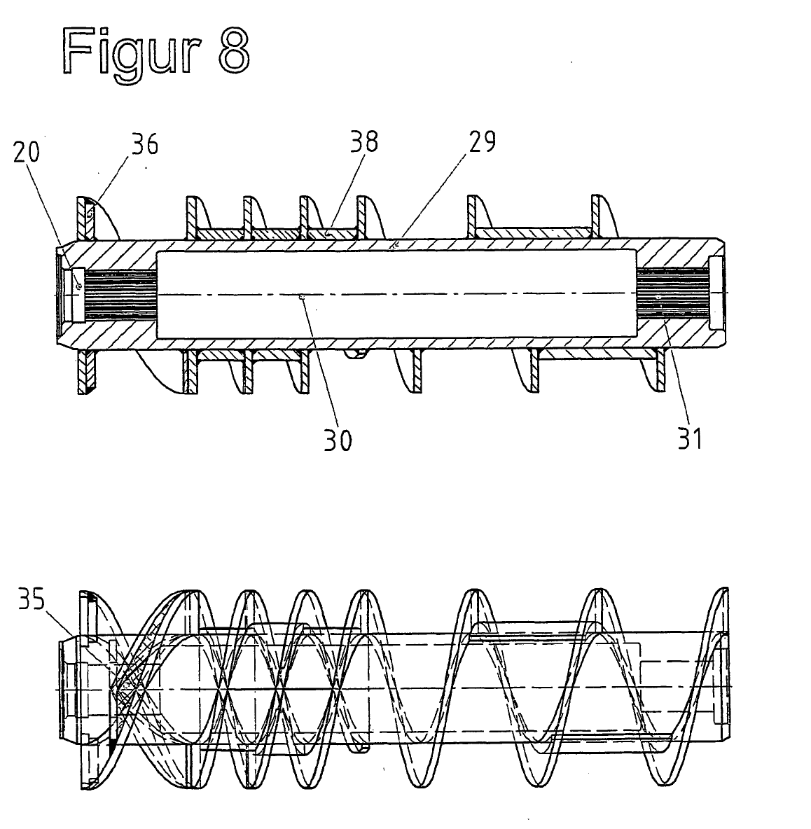

Reference should additionally be made to FIGS. 8 and 9 concerning the construction of the body screw 28 and the working screw 29 in the form of a plug-in screw.

The body screw 28 is in part constructed as a double-start screw, whose screw channels 32 extend over its length, which corresponds to the length of the mincer filling hopper 5. Subsequently the body screw 28 passes into a smooth driving shaft 43, which is terminally constructed with a hexagonal journal 44, which corresponds to the hexagonal recess 19 of the connecting piece 20 of the knife journal 18.

Besides the fixed connection to the double flanges 39, the body screw 38 can also be produced as a loose connection, in which the body screw 28 is then constructed with a profiled blind bore, which engages a connecting piece 45 and provides the connection to the double flange 39 and the driving shaft journal 41.

The working screw 29 is constructed with a hollow shaft 30 and as a plug-in screw and has a reinforced screw core 38 in the final third of the discharge-side area. This area is constructed as a four-flow distributing screw 36. The four-flow feed of the mincing material enters into the pressure impulse pieces 35 that are arranged in pairs on the final screw channels of the four-flow distributing screw 36. The pressure impulse pieces 35 are preferably wedge-shaped and their end face points in the mincing material feed direction. The pressure impulse pieces 35 bring about a subdivision into four feed flows, which in this form strike the individual quadrants of the first cutter set part of the block cutter set 3.

To assist and reinforce the pressure buildup and feed rate in the area of the four-flow distributing screw 36, the final screw channels of the working screw have a smaller lead than in the starting area, which leads to an additional constriction of the feed cross-section of the working screw 29. This results in an improved pressing in of the mincing material in the direction of the following block cutter set 3 and also pressure assistance for the working screw 29.

What is claimed is:

1. Shredding machine operating according to the mincer principle, having a filling hopper for receiving the material to be shredded, a feed screw, a working screw and a following cutter set, in which
the feed screw (28) is mounted below the filling hopper (5) in a housing (1) of the shredding machine,
the working screw (29) is detachably connected in non-rotary manner to the feed screw (28),
between the feed screw (28) and working screw (29) is provided a precutting device (9),
a split pressure housing (2) surrounding the working screw (29) is pivotably held on the housing (1),
on a discharge-side end section of the pressure housing (2) is detachably held a block cutter set (3), which alternately has coaxially arranged rotary and stationary cutting elements (14, 23, 24), the rotary cutting elements (14, 24) being located on a knife shaft (18) connected in detachable, non-rotary manner to the working screw (29) and the stationary cutting elements (23) are braced with locking screws (15) between an adaptor plate (16) to be fixed at the discharge-side end section of the pressure housing (2) and a support element (22), and in which an end section of the knife shaft (18) is mounted in rotary manner in the support element (22).

2. Shredding machine according to claim 1, characterized in that the working screw (29) is constructed as a plug-in screw connectable to the feed screw (28) in rotation angle positions which can be varied as desired.

3. Shredding machine according to claim 1 or 2, characterized in that the stationary cutting elements are formed by at least one perforated disk (23) and/or a precutter (24).

4. Shredding machine according to claim 3, characterized in that at least one stationary cutting element (23) is formed by at least two engaging perforated disks (23), as a function of the state of wear and the desired thickness of the particular cutting element.

5. Shredding machine according to the preceding claims, characterized in that the rotary cutting elements are formed by at least one knife (14).

6. Shredding machine according to one of the preceding claims, characterized in that the stationary cutting elements are polygonal, particularly square, the locking screws (15) being positioned in the corners.

7. Shredding machine according to one of the preceding claims, characterized in that the knives (14) are constructed as spacer knives and a knife spacer (25) is associated with each spacer knife (14).

8. Shredding machine according to one of the preceding claims, characterized in that the feed screw is constructed as a double-start body screw (28).

9. Shredding machine according to one of the preceding claims, characterized in that the feed screw (28) is connected by means of a double flange connection (39) to a driving shaft journal (41).

10. Shredding machine according to one of the preceding claims, characterized in that the working screw (29) has a reinforcing screw core (38) in the feed direction.

11. Shredding machine according to one of the preceding claims, characterized in that at the discharge side the working screw (29) is constructed as a four-flow distributing screw (36).

12. Shredding machine according to claim 11, characterized in that on the flanks of the in each case last screw channels of the working screws (29) are placed pressure impulse elements (25) forming with the reinforced screw core (38) the four-flow distributing screw (36).

13. Shredding machine according to one of the preceding claims, characterized in that a discharge-side screw channel end of the feed screw (28) is equipped with replaceable cutting blades (33) of a knife body provided with cutting blades and between the housing (1) and pressure housing (2) is located a precutter (34), which forms with the cutting blades (33) the precutting mechanism (9).

14. Shredding machine according to one of the preceding claims, characterized in that on the inner walls of the pressure housing (2) are detachably held support/twist units (8), on which the working screw (29) is supported in rotary manner.

15. Shredding machine according to claim 14, characterized in that the support/twist units (8) are constructed as half-shells.

16. Shredding machine according to one of the preceding claims, characterized by an adjusting mechanism (12) for opening and closing the parts of the pressure housing (2).

17. Shredding machine according to one of the preceding claims, characterized in that the adaptor plate (16) is provided with an outer circumferential groove (17).

18. Shredding machine according to one of the preceding claims, characterized in that the support element (22) is provided with a hand protection to prevent entry.

19. Shredding machine according to one of the preceding claims, characterized in that the block cutter set (3) has at least one connection (27) for the introduction of additives or other media, particularly heating steam or current.

20. Shredding machine according to one of the preceding claims, characterized in that a wedge-like tapering, adjustable insert aid (13) is placed in the filling hopper (5).
